(19) United States
(12) Patent Application Publication
(10) Pub. No.: US 2021/0142397 A1
(43) Pub. Date: May 13, 2021

(54) SYSTEMS AND METHOD FOR A SOURCING HUB

(71) Applicant: ServiceNow, Inc., Santa Clara, CA (US)

(72) Inventors: Bharath Soundararajan, Fremont, CA (US); Amir Vakili Jafari, Los Gatos, CA (US); Senthil Rajavallipuram Meenakshisundaram, Fremont, CA (US)

(21) Appl. No.: 16/681,345

(22) Filed: Nov. 12, 2019

(51) Int. Cl. G06Q 30/08; G06Q 40/04; G06Q 30/06; G06Q 10/08; G06Q 30/02; G06Q 20/40

(52) U.S. Cl. CPC G06Q 30/08; G06Q 40/04; G06Q 30/0611; G06Q 20/40; G06Q 30/0214; G06Q 30/0222; G06Q 10/087

(57) ABSTRACT

A sourcing hub analyzes data to predict upcoming demand for goods and/or services. The sourcing hub requests bids or quotes from one or more vendors via a vendor up to provision the goods and/or services. The sourcing hub receives and considers bids from the vendors, selects a bid and associated vendor, and then initiates purchasing of the goods and/or services.

### BACKGROUND

The present disclosure relates generally to systems for managing procurement of goods and services within an enterprise.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Typically, procurement within an enterprise is based on purchasing requests. A division, group, or individual recognizes a need or desire for some good or service and submits a purchase request. The purchase request may be sent to one or more other groups or individuals for consideration and subsequent approval or denial. Considerations may include whether there is sufficient budget for the good or service, whether the requested good or service is appropriate, whether the good or service is really needed, and so forth. Once a purchase request is approved, an order is initiated with an approved vendor. To become an approved vendor, vendors go through a long and arduous onboarding process that may include providing documentation, contract negotiations, communication with a legal department, sending quotes and/or sample products, etc. Further, communications between vendors and various individuals or groups within the enterprise may be dispersed over emails, phone calls, in person meetings, facsimile, postal mail, etc. Once a vendor has been onboarded, the requested goods or services can be ordered from the vendor. However, because purchasing is based on requests submitted by divisions, groups, or individuals within the enterprise that are not aware of needs throughout the rest of the enterprise, the enterprise may not take full advantage of its buying power to buy larger quantities of goods or services and negotiate lower per-unit prices for those goods or services.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to techniques for implementing a sourcing hub. The sourcing hub may consider historical purchasing data, as well as upcoming projects and initiatives to predict upcoming demand for goods and/or services for an enterprise. The sourcing hub requests bids from one or more vendors via a vendor hub, which acts as a portal for vendors to interact with an enterprise. Once bids have been submitted, the sourcing hub may select a winning bid and generate a purchase requisition. In some embodiments, the purchase requisition may be sent to a reviewing individual or department for approval. In other embodiments, the purchase requisition may automatically initiate an order from the vendor.

In some embodiments, the sourcing hub may also be used for vendor management. For example, the sourcing hub may periodically conduct searches for new vendors, for example, by searching various online marketplaces. When a new vendor is found or recommended, the new vendor may be onboarded via the vendor hub. Once a vendor has access to the vendor hub, they may place bids to provide various goods and services via the vendor hub. As a vendor places bids and fulfills orders, data may be collected to evaluate the vendor. Data may include, for example, user reviews, time to delivery, rate at which orders are returned, product/service quality, instances of the vendor coming in under budget or over budget, customer service, ease of billing, etc. One or more vendor metrics may be calculated based on the collected data. If a vendor does not meet expected performance standards, the vendor may be put on probation or recommended for offboarding.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of the multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a schematic of a framework for purchasing goods and/or services within an enterprise, in accordance with aspects of the present disclosure;

FIG. 6 is a schematic illustrating interactions between a sourcing hub and a vendor hub within the framework shown in FIG. 5, in accordance with aspects of the present disclosure;

FIG. 7 illustrates an architecture of tables from which the sourcing hub may collect data, in accordance with aspects of the present disclosure;

FIG. 8 is a flow chart of a process for predicting future demand for goods and/or services by an enterprise and having one or more vendors bid to satisfy the demand, in accordance with aspects of the present disclosure; and

FIG. 9 is a flow chart of a process for vendor management within the framework shown in FIG. 5, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, the term “configuration item” or “CI” refers to a record for any component (e.g., computer, device, piece of software, database table, script, webpage, piece of metadata, and so forth) in an enterprise network, for which relevant data, such as manufacturer, vendor, location, or similar data, is stored in a CMDB.

The disclosed techniques relate to implementing a sourcing hub that recognizes trends in historical purchasing data for an enterprise and considers upcoming projects to predict upcoming demand for goods and/or services. The sourcing hub requests bids from one or more vendors via a vendor hub. The sourcing hub may select a winning bid and initiate an order from the vendor for the good or service in question. The sourcing hub may also perform vendor management. This may include periodically conducting searches for new vendors, vetting potential new vendors, and onboarding new vendors via the vendor hub. As a vendor places bids and fulfills orders, data may be collected to calculate one or more vendor metrics for evaluating the vendor. Data may include, for example, user reviews, time to delivery, rate at which orders are returned, product/service quality, instances of the vendor coming in under or over budget, customer service, ease of billing, etc. If a vendor does not meet expected performance standards, the vendor may be put on probation or recommended for offboarding.

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

With the preceding in mind, FIG. 4 is a block diagram illustrating an embodiment in which a virtual server 250 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a web browser of the client device 20D). The client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

In some embodiments, an enterprise may use the cloud-based computing architecture shown and described with regard to FIGS. 1-4 to facilitate procurement for the enterprise. For example, the cloud-based architecture may be used to provide a system for identifying an enterprise's demand for goods and/or services and then communicating with one or more vendors to bid on providing those goods and/or services. FIG. 5 is a schematic of a framework 300 for purchasing goods and/or services within an enterprise. As shown, a product listing 302 is generated based on products available from one or more vendors 304. A product model API 306 extracts and updates product model data for the products listed in the product listing 302. As shown, the product model data may include, for example, manufacturer part number or UPC, model name, product description, vendor, vendor part number, unit price, country/region, managed by, model category, compatible products, substitute products, image and/or icon, department, lead time, in-stock or out of stock, etc. The product model API 306 may update on a regular schedule (e.g., every Saturday night) to ensure that all relevant fields for existing products are up to date and any new product models have been added. The product model API 306 may also be configured to update on demand based on a command from a catalog administrator. If an update or an addition of a new product fails, the status code will be captured, reviewed by the catalog administrator and added manually. When new products are added, an approval task may be sent to the catalog administrator for approval. Once approved, the product will be available for users to view and purchase.

An offer API 310 pulls or receives data from the vendors 304 corresponding to various promotional offers from the vendors 304 for one or more of the products collected by the product model API 306. The offer API 310 updates on a regular schedule (e.g., every 12 hours), but an update can be initiated on-demand by the catalog administrator. The offer API 310 may collect and store data corresponding to the vender ID, offer ID, unit price, the current promotional offer price, offer validity, previous promotional offer prices, and so forth. The promotional information may be retained while the offer is valid (i.e., until the offer expires). Upon expiration of the offer, the displayed price may return to the normal unit price. All purchase orders created for items with a promotional offer may include an offer identification number and offer price for respective performance linked incentives. The offer identification number, and in some cases, other offer data will be available for both purchase requisition and purchase order line items. When new offers are added, review tasks will be created for the catalog administrator to review the new offers.

The offer API routes promotional offer details to a deal hub 312. The deal hub 312 acts as a transactional repository of all offers (current or expired) that have been offered by vendors 304 via the offer API 310. In some embodiments, only select users will have access to the deal hub 312. The deal hub 312 may display data related to an offer, such as vender name, deal source, offer ID, validity, unit price, currency, region, product model name, category, etc. Active deals with the lowest offer price for each vender will be displayed to the user with the vendor catalog item that corresponds to the product model. The offer will only display if the offer is valid. If there is no valid offer, the offer category will display as null. Further, if the deal is active, it may be flagged as “active” or otherwise emphasized/highlighted. Upon expiration of an offer, the offer will no longer be displayed to the user, but offer information will be saved and stored for future analysis and reference. In some embodiments, some users (e.g., catalog administrator or strategic sourcing team) may have the authority to create an offer manually. Further, some users may have the authority to request a quote from a vendor.

In some embodiments, the framework 300 may also include a price check API 313 that checks for lower prices than those listed in the catalog. In such embodiments, the price check API 313 may be a dynamic API that runs behind the scenes to validate price information on an in-flight purchase requisition by querying manufacturer part number and/or UPC on performance linked incentives. When the manufacturer part number and/or UPC is successfully validated on active performance linked incentives, the price check API 313 calls associated endpoints to validate whether or not there are lower prices available (e.g., better promotional offers) to be taken advantage of. Accordingly, the price check API 313 may be utilized to catch price reductions or competing offers on a vendor's platform. If competing price points exist, the lowest priced option will be updated to the catalog item as the unit price. The performance linked incentives will also be updated accordingly. The new lower price will exist as the new default unit price until the price is updated by the vendor.

Information from the product model API 306 and the offer API 310 (via the deal hub 312) may be combined to create a vendor catalog item 308 for each product available for purchase. The various catalog items 308 combine to form a product catalog 314. The product catalog 314 is accessible by users via a marketplace 318 (e.g., ShopNow) with a peer-to-peer (P2P) dashboard interface that users may use to place orders for products within the product catalog 314. In general, products will be auto-published to the marketplace 318, but the catalog administrator may have the authority to publish or unpublish items via a catalog interface. Some items or categories of items may be set up to require a catalog administrator's approval before being listed on the marketplace for purchase. A scheduled job may be run at regular intervals (e.g., every hour, every 4 hours, every 6 hours, every 12 hours, once a day, etc.) to automatically publish items that are approved for publishing, but have not published yet. However, the catalog administrator may also have the authority to run the scheduled job upon request on demand. Items that have been manually removed from the marketplace 318 by the catalog administrator will be marked as “retired” and will not be republished unless the status is updated to reinstated by the catalog administrator.

A purchase requisition component 320 may automatically generate purchase requisitions based on purchase requests submitted by users. In some embodiments, the purchase requisitions may be submitted to a reviewer for approval. Purchase requisitions may then be provided to a financial management platform 322, such as SAP® Financials, and then through an order API 324 that communicates the order to the vendor 304. A number of other integrated platforms may use order data for various purposes. For example, a dynamic discounting and supplier information and performance management platform 326, such as SAP® ARIBA® may pull order data for analysis.

As shown in FIG. 5, a procurement management platform 328, such as SCOUT®, and a sourcing hub 340 may act as interfaces between the purchase requisition component 320 and a vendor hub 330. The vendor hub 330 acts as a portal, dashboard, or other interface through which vendors 304 interact with the enterprise. In some embodiments, the vendor hub 330 may be accessible via a customer instance of a cloud architecture (e.g., a multi-instance cloud architecture). For example, the vendors 304 may submit bids or quotes via the vendor hub 330. The vendor hub 330 may also facilitate onboarding of new vendors 304, offboarding of old vendors 304, negotiations with vendors 304 regarding prices, quality control, contracts, vendor agreements, etc. In some embodiments, vendor ratings and feedback may also take place via the vendor hub330. Further, purchase orders, invoices, payment, etc. may be exchanged via the vendor hub330. In some embodiments, the vendor hub 330 may also include the capability to chat and/or send messages. Accordingly, the vendor hub 330 may bring communications and exchanges of information that take place via phone call, email, facsimile, paper or postal mail, and so forth into a single portal, thus allowing for more effective and efficient maintenance of vendor relationships. In some embodiments, the vendor hub 330 may be accessible via a customer instance of a cloud architecture (e.g., a multi-instance cloud architecture).

As is described in more detail below, the sourcing hub 340 may be configured to analyze purchasing history, as well as upcoming projects and/or incentives to predict upcoming purchases (e.g., purchases in a period of time that has not yet occurred) across one or more groups or divisions within an enterprise. The sourcing hub 340 may then present the predicted demand to one or more selected vendors 304 for bids. Accordingly, multiple groups or divisions within the enterprise may combine their demand to collectively bargain for better per-unit prices for goods and/or services. Further, having multiple vendors bid against one another to satisfy the demand for goods and/or services may further reduce the price of those goods and/or services. The procurement management platform 328, displayed in FIG. 5 as “RFx” may be used by the sourcing hub 340 to generate requests for proposal (RFP), requests for information (RFI), requests for quote (RFQ), requests for bid (RFB), etc. that are then provided to the vendors 304 via the vendor hub 330. Once a bid is selected, the sourcing hub 340 may notify the purchase requisition component 320 of the selected bid. The purchase requisition component 320 may then generate a purchase requisition to be sent to the financial management platform 322 to initiate the purchase.

The vendor hub 330 may provide data to the SAP® Financials platform 322 and to a contract lifecycle management platform 332, such as APTTUS®. Other platforms, such as, for example, TANGO® 334, TAXWARE® 336, etc., may also provide data to SAP® Financials 322. For the sake of simplicity, the various platforms shown in FIG. 5 are connected by lines and/or arrows, indicating communication between the platforms. It should be understood, however, that each of the communication arrows may be implemented by middleware (e.g., middleware running on-premises or on a remote server, or a cloud-based middleware instance) instance.

Once the vendor 304 ships the product, data may be provided to a shipment API 338 that provides shipping information about the shipped product to the product catalog 314. The shipping information may include, for example, the shipping carrier, tracking ID number, ship date, expected delivery date, delivery date (if already delivered), and product information, such as tag number, serial number, MAC, etc.

FIG. 6 is a schematic illustrating interactions between the sourcing hub 340 and the vendor hub 330. As previously described, the vendor hub 330 is a portal by which vendors 304 may interact with the enterprise. These interactions may include, for example, onboarding/offboarding vendors, requests for bids, submitting bids, scheduling service, facilitating returns, sending purchase orders, sending invoices, sending payment, contract/agreement negotiations, sending messages, etc. In some embodiments, the vendor hub 330 may be accessible via a customer instance of a cloud architecture (e.g., a multi-instance cloud architecture). The vendor hub 330 may be accessible to existing vendors 400, as well as new vendors 402 that are being considered for onboarding, being onboarded, or were recently onboarded.

The activity of the sourcing hub 340 can be broken up into two categories. The first category includes predicting upcoming demand for goods and/or services across one or more divisions of the enterprise, presenting the demand to one or more vendors 304 to bid on, and considering bids placed by vendors 304. The second category can be described as vendor management and can include finding new vendors to onboard, collecting and analyzing vendor feedback, and offboarding vendors 304 that are not meeting expected performance standards (e.g., delivery time, price points, quality of goods/services, etc. do not meet some set threshold values).

As shown in FIG. 6, a financial planning and analysis group or component 404 may provide historical purchasing data 406 to the sourcing hub 340. The historical purchasing data 406 may include purchasing history for the enterprise over one or more years. In some embodiments, the historical purchasing data 406 may include budgets vs. actual spending over one or more years. The sourcing hub 340 analyzes the historical purchasing data 406 to identify trends in the data (e.g., the enterprise tends to purchase a large quantity of a good or service during a particular month or time of year). For example, the enterprise may hire an outside accounting or auditing service during tax season and/or for the financial close at the end of a quarter or end of the fiscal year. In another example, the enterprise may replace pieces of equipment at set intervals, or may on average replace a certain number of pieces of equipment (e.g., personal computers) each year. Accordingly, the sourcing hub 340 may use the historical purchasing data 406 and the trends identified therein to predict demand for goods or services during an upcoming period of time (e.g., demand for a particular good or service over the next week, month, quarter, etc.).

A procurement performance management component 408 may provide data to the sourcing hub 340 identifying upcoming projects and key initiatives for the enterprise. In addition to the historical purchasing data 406, data about upcoming projects and key initiatives for the enterprise may provide a clearer picture about upcoming demand for goods and/or services for the enterprise. That is, the enterprise may be undertaking a new project or initiative that may cause demand, or increased demand, for particular goods and/or services. In some circumstances, the new project or initiative may not be reflected in the historical purchasing data 406. Accordingly, consideration of the new project or initiative may help the sourcing hub 340 to better predict upcoming demand for goods and/or services.

Once the sourcing hub 340 as analyzed the collected data to predict upcoming demand for goods and/or services, the sourcing hub 340 may generate a bill of materials 410 indicating a list of goods and/or services expected to be purchased in the upcoming time period. The sourcing hub 340 may then create an RFx 412 to be sent to the vendors 304 via the vendor hub 330. The RFx 412 may include, for example, a request for proposal (RFP), a request for information (RFI), a request for quote (RFQ), a request for bid (RFB), etc. for one or more of the items listed in the bill of materials 410. In some embodiments, multiple RFxs 412 may be exchanged. For example, the sourcing hub 340 may send a request for information (RFI), to which a vendor 304 may respond by providing information (e.g., specifications for a particular model, a recommendation for a particular part or service, etc.). Based on the information provided by the vendor 304, the sourcing hub 340 may then generate a request for quote (RFQ) or a request for bid (RFB) for the selected good or service. One or more vendors 304 may then respond to the request for quote (RFQ) or a request for bid (RFB) with bids or quotes to provide the good or service. In some embodiments, there may be a set window of time during which vendors 304 may provide bids or quotes. The sourcing hub 340 may then consider the bid or quotes provided and select a vendor's 304 bid. The sourcing hub 340 may then create a purchase requisition 414. In some embodiments, the purchase requisition 414 may be sent to a reviewer (e.g., the financial planning and analysis group) for approval. In other embodiments (e.g., purchases below a threshold dollar amount, purchases for specific items, purchases from specific vendors, pre-approved purchases, etc.), the purchase requisition 414 may be automatically used to initiate a purchase from the vendor 304.

As previously discussed, the sourcing hub 340 may also be used for vendor management via the vendor hub 330. For example, the sourcing hub 340 may periodically conduct searches for sources of desired goods and/or services outside of the current vendors 400. This may include, for example, searching various online marketplaces, searching the world wide web for other vendors, searching online catalogs, finding recommended vendors, etc. Once a new vendor 402 is found, the new vendor 402 may be given limited access to the vendor hub 330 in a new vendor role. For example, a new vendor role within the vendor hub 330 may grant the new vendor 402 limited capabilities relative to fully onboarded current vendors 400. A vendor 304 may be designated as a new vendor 402 before and during onboarding. Onboarding may include, for example, providing information, vetting of the vendor, credit checks, etc. In some embodiments, new vendors 402 may be able to submit bids before or during the onboarding process. In such cases, the new vendor's 402 bid may be contingent upon being successfully onboarded. Previous onboarding processes may have been less standardized and included, for example, a representative from the enterprise reaching out via email requesting more information (RFI) about the vendor (e.g., number of employees, revenues, establishment type, etc.) and/or a sample product/service, the representative evaluating the sample product/service, assessing vendor risk, negotiating the terms of a vendor agreement, the representative submitting a vendor onboarding request, the vendor onboarding request being approved, a long onboarding process involving the legal department and contract negotiations, and then negotiating prices once the vendor has been onboarded. In contrast, in the instant embodiments, the onboarding process may include the vendor being recommended by the sourcing hub 340, considering benefits offered by the recommended vendor, adding vendor to the vendor hub, the vendor placing bids via vendor hub, and then going through shortened onboarding process in which information is exchanges via the vendor hub 330.

Once a new vendor 402 has been onboarded, the vendor becomes a current vendor 400. As bids are placed and vendors 304 are used, data may be collected and feedback provided by users for vendors 304. Accordingly, based on the collected data and feedback provided by users, metrics may be calculated and tracked for vendors 304, resulting in a vendor rating system. Metrics may consider and/or be representative of delivery time, rate at which orders are returned, product/service quality, instances of the vendor coming in under or over budget, customer service, ease of billing, etc. If a vendor is not meeting expected performance standards for one or more metrics, the vendor may be placed on probation and/or offboarded as a vendor.

FIG. 7 illustrates an architecture 500 of tables from which the sourcing hub 340 may collect data. It should be understood that “collect data” is intended to encompass the sourcing hub 340 pulling data from tables and/or data being pushed from the tables to the sourcing hub 340. The pulling and/or pushing of data may be directly between the sourcing hub 340 and the tables, or indirectly through some intermediate component. For example, in some embodiments, an intermediate component may pull data from one or more of the tables and push the data to the sourcing hub 340.

As shown in FIG. 7, data may be collected from one or tables associated with a purchase requisition backend application of the purchase requisition component 320. These tables may include, for example, an other_administration table 502 storing administrative data, a u_vendor_code table 504 storing vendor codes on the one or more vendors of the vendor hub, a u_pr_line item table 506 storing line items from purchase requisitions, and a u_pr_header table 508 storing headers from purchase requisitions. The sourcing hub 340 may also collect data from a maintain_item table 510, which stores data associated with catalog items available for order within the service catalog. As shown in FIG. 7, the sourcing hub 340 may collect data from a core company table 512, which stores data associated with the enterprise and references other subtables, from which the sourcing hub 340 may also collect data. For example, the core_company table 512 references a cmdb_model_category table 514, which may include data about models of devices on the enterprise's network and stored in the CMDB. The cmdb_model_category table 514 may further reference a u_fin_config subtable 516 and a u_sub_category subtable 518. The core_company table 512 may also reference a cmdb_ci_model table 520, which may include data about models of components on the enterprise's network and stored as configuration items in the CMDB. The cmdb_ci_model table 520 may further reference a hardware_model subtable 522, which stores information about models of hardware owned by the enterprise, a consumable_model subtable 514, which stores information about models of consumables used by the enterprise, a software_model subtable 526, which stores information about models of software used by the enterprise, and a contract_model subtable 528, which stores information about contracts used by the enterprise. The core_company table 512 may further reference an alm_hardware subtable 530, which stores information about hardware assets owned by the enterprise, an alm_consumable subtable 532, which stores information about consumables assets used by the enterprise, an alm_software subtable 534, which stores information about software assets used by the enterprise, an alm_license subtable 536, which stores information about licensed assets used by the enterprise, or assets licensed to other entities, and a ast_contract subtable 538, which stores information about contracted assets used by the enterprise. The core_company table 512 may also reference a vendor_catalog_item table 540, which may include data about vendor catalog items which the enterprise has purchased or may be interested in purchasing. Finally, the sourcing hub 340 may reference a cmdb_communication_device table 542, which may store information about communication devices used on the enterprise's network and referenced in the CMDB, and a cmdb_circuits table 544, which may store information about communication circuits used on the enterprise's network and referenced in the CMDB. It should be understood however, that the tables listed in FIG. 7 are merely examples, and not intended to be limiting. Accordingly, the sourcing hub 340 may not collect data from all of the tables shown in FIG. 7 and may collect data from other tables not shown in FIG. 7.

FIG. 8 is a flow chart of a process 600 for predicting future demand for goods and/or services by an enterprise and having one or more vendors bid to provide the goods and/or services. As shown, at block 602, the process receives historical purchasing data. As previously described, the historical purchasing data may include, for example, purchasing history for the enterprise over one or more years, budgets vs. actual spending over one or more years, purchased goods and/or services, etc. As described above with regard to FIG. 7, receiving historical purchasing data may also include collecting data from one or more tables stored on the network's enterprise. At block 604, the collected data is analyzed to identify trends. For example, the enterprise may regularly purchase a large quantity of a good or service during a particular month or time of year (e.g., hiring an outside accounting or auditing service during tax season and/or for the financial close at the end of a quarter or end of the fiscal year). In another example, the enterprise may replace pieces of equipment at set intervals, or may on average replace a certain number of pieces of equipment (e.g., personal computers) each year.

At block 606, data regarding upcoming projects and/or initiatives is received. Data about upcoming projects and initiatives for the enterprise may provide a clearer picture about upcoming demand for goods and/or services for the enterprise. For example, the enterprise may plan to undertake a new project or initiative that may cause new demand, or increased demand, for particular goods and/or services. The planned project or initiative may not be reflected in the historical purchasing data received in block 602 and analyzed in block 604. Accordingly, consideration of the planned project or initiative may help to better predict upcoming demand for goods and/or services.

At block 608, upcoming demand for one or more goods or services is estimated. For example, the historical purchasing data, the trends identified therein, and the planned projects and/or initiatives may be used to predict upcoming demand for goods or services (e.g., demand for a particular good or service over the next week, month, quarter, etc.). In some embodiments, estimating upcoming demand for one or more goods or services may include generating a bill of materials for goods and/or services.

At block 610, a request for information (RFI) may be may be generated and transmitted to one or more vendors regarding one or more goods and/or services. In some embodiments, the RFI may be transmitted to the one or more vendors via the vendor hub. The vendors may respond by providing the requested information (e.g., specifications for a particular model, a recommendation for a particular part or service, etc.). At block 612 a request for quote (RFQ) or a request for bid (RFB) may be generated and transmitted to one or more vendors via the vendor hub. It should be understood that in some embodiments, the block 610 may be skipped and the process may proceed directly from block 608 to block 612. One or more vendors may then respond to the request for quote (RFQ) or a request for bid (RFB) by submitting bids or quotes to provide the good or service via the vendor hub. In some embodiments, there may be a set window of time during which vendors may provide bids or quotes. At block 614, the bids/quotes may be considered and a vendor selected. Selection may be based on one or more factors, such as price, vendor rating, delivery time, available stock, requester preference, prior history with vendor, etc. At block 616, a purchase requisition may then be created. In some embodiments, the purchase requisition may be sent to a reviewer (e.g., the financial planning and analysis group) for approval. In other embodiments (e.g., purchases below a threshold dollar amount, purchases for specific items, purchases from specific vendors, pre-approved purchases, etc.), the purchase requisition may be automatically used to initiate a purchase from the selected vendor.

FIG. 9 is a flow chart of a process 700 for vendor management. At block 702, the process 700 searches for new vendors. This may include, for example, searching various online marketplaces, searching the web for other vendors, finding recommended vendors, etc. Searches for new vendors may occur, for example, on a regular schedule, upon request, upon the number of vendors for a given good/service dropping below a threshold value, upon recognition that one or more existing vendors are not meeting expected performance standards, etc. Upon finding a new candidate vendor, the candidate vendor is evaluated (block 704). Evaluation may include, for example, collecting information, vetting of the vendor, evaluating the ratings of the vendor in other marketplaces, evaluating outside rating services, performing credit checks, considering cost savings and/or benefits of using the vendor, etc. At block 706, the new candidate vendor is recommended for onboarding. In some embodiments, new vendors may be able to submit bids before or during the onboarding process. In such cases, the new vendor's bid may be contingent upon being successfully onboarded. At block 708, the new vendor is onboarded via the vendor hub. In some embodiments, the new vendor may have restricted access to the vendor hub before being fully onboarded.

At block 710, bids and/or quotes are requested and received from the vendor via the vendor hub to satisfy predicted future demand for goods/services. In some embodiments, there may be a set window of time during which vendors may provide bids or quotes. The bids/quotes may be considered, a vendor selected, and a purchase requisition may then be created. The purchase requisition may be sent to a reviewer for approval, or the purchase requisition may be automatically used to initiate a purchase from the selected vendor.

At block 714, data is collected during the course of the transaction and following the delivery of goods/services. The data may include, for example, time to delivery of goods/services, whether an expected delivery date was met, quality of goods/service, whether goods/services were returned/exchanged, whether any follow-up was needed, and so forth. At block 716, the date collected in block 714 may be used to calculate and track one or more vendor metrics. If the tracked vendor metrics meet expected performance standards (e.g., delivery time, price points, quality of goods/services, etc.), the process 700 may return to block 710 and request new bids/quotes from the vendor. If the tracked vendor metrics do not meet expected performance standards, the process may proceed to block 718 and the vendor may be put on probation (e.g., restricted access to the vendor hub, restricted ability to provide bids/quotes, closer monitoring, etc.), or recommended for offboarding if the vendor is already on probation or if the vendor metrics fall a threshold amount below the expected performance standards. Offboarding a vendor may include restricting or completely revoking access to the vendor hub, no longer allowing a vendor to provide quotes/bids, or otherwise severing ties with a vendor.

The present disclosure relates to techniques for implementing a sourcing hub. The sourcing hub may consider historical purchasing data, as well as upcoming projects and initiatives to predict upcoming demand for goods and/or services for an enterprise. The sourcing hub may then request bids from one or more vendors via a vendor hub, which may act as a portal for vendors to interact with an enterprise. Once bids have been submitted, the sourcing hub may select a winning bid and generate a purchase requisition. In some embodiments, the purchase requisition may be sent to a reviewing individual or department for approval. In other embodiments, the purchase requisition may automatically initiate an order from the vendor.

The sourcing hub may also be used for vendor management. For example, the sourcing hub may periodically conduct searches for new vendors, for example, by searching various online marketplaces. When a new vendor is found or recommended, the new vendor may be onboarded via the vendor hub. Once a vendor has access to the vendor hub, they may place bids to provide various goods and services via the vendor hub. As a vendor places bids and fulfills orders, data may be collected to evaluate the vendor. Data may include, for example, user reviews, time to delivery, rate at which orders are returned, product/service quality, instances of the vendor coming in under or over budget, customer service, ease of billing, etc. One or more vendor metrics may be calculated based on the collected data. If a vendor does not meet expected performance standards, the vendor may be put on probation or recommended for offboarding.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processor; and
a memory, accessible by the processor, the memory storing instructions that, when executed by the processor, cause the processor to perform actions comprising:
receiving historical purchasing data for a first period of time that has already occurred;
identifying one or more trends in the historical purchasing data;
predicting upcoming demand for goods or services during a second period of time that has not yet occurred based on the one or more identified trends;
generating a request for bid (RFB) to provision the goods or services;
transmitting the RFB to a plurality of vendors, via a vendor hub accessible via a customer instance of a cloud-based architecture;
receiving, via the vendor hub, a plurality of respective bids to provision the goods or services from the plurality of vendors;
selecting a first bid of the plurality of bids associated with a first vendor of the plurality of vendors; and
generating a purchase requisition to purchase the goods or services from the first vendor.

2. The system of claim 1, the actions comprising:
receiving data defining one or more upcoming projects occurring during the second period of time; and
predicting the upcoming demand for the goods or services during the second period of time based on the identified trends and the one or more upcoming projects occurring during the second period of time.

3. The system of claim 1, the actions comprising:
receiving data from one or more tables identifying an enterprise's existing assets; and
predicting the upcoming demand for the goods or services during the second period of time based on the identified trends and the enterprise's existing assets.

4. The system of claim 1, the actions comprising generating a bill of materials based on the predicted upcoming demand for goods or services during the second period of time.

5. The system of claim 1, the actions comprising:
searching one or more online marketplaces to identify one or more candidate new vendors;
recommending the one or more candidate new vendors for onboarding; and
providing the one or more candidate new vendors with access to the vendor hub.

6. The system of claim 1, the actions comprising:
collecting data associated with the first vendor; and
calculating one or more vendor metrics associated with the collected data.

7. The system of claim 6, the actions comprising:
identifying when the one or more vendor metrics fall below one or more respective threshold values that define a set of expected performance standards for the first vendor; and
offboarding the first vendor.

8. The system of claim 1, wherein selecting the first bid of the plurality of bids is based on a price for the goods or services, a vendor rating for the first vendor, an estimated delivery time for the goods or services, the first vendor having the goods or services in stock, or a combination thereof.

9. A method, comprising:
receiving historical purchasing data for a first period of time that has already occurred;
identifying one or more trends in the historical purchasing data;
receive data defining one or more upcoming projects occurring during a second period of time that has not yet occurred;
predicting upcoming demand for goods or services during the second period of time based on the one or more identified trends and the one or more upcoming projects occurring during the second period of time;
generating a request for bid (RFB) to provision the goods or services;
transmitting the RFB to a plurality of vendors, via a vendor hub accessible via a customer instance of a cloud-based architecture;
receiving, via the vendor hub, a plurality of respective bids to provision the goods or services from the plurality of vendors;
selecting a first bid of the plurality of bids associated with a first vendor of the plurality of vendors; and
generating a purchase requisition to purchase the goods or services from the first vendor.

10. The method of claim 9, comprising:
receiving data from one or more tables identifying an enterprise's existing assets; and
predicting the upcoming demand for the goods or services during the second period of time based on the one or more identified trends, the one or more upcoming projects occurring during the second period of time, and the enterprise's existing assets.

11. The method of claim 9, comprising: generating a bill of materials based on the one or more identified trends and the one or more upcoming projects occurring during the second period of time.

12. The method of claim 9, comprising:
searching one or more online marketplaces to identify one or more candidate new vendors;
recommending the one or more candidate new vendors for onboarding; and
providing the one or more candidate new vendors with access to the vendor hub.

13. The method of claim 9, comprising:
collecting data associated with the first vendor; and
calculating one or more vendor metrics associated with the collected data.

14. The method of claim 13, comprising:
identifying when the one or more vendor metrics fall below one or more respective threshold values that define a set of expected performance standards for the first vendor; and
offboarding the first vendor.

15. A non-transitory, computer-readable medium having instructions stored thereon that, when executed by a processor, cause the processor to perform actions comprising:
receiving historical purchasing data for a first period of time that has already occurred;
identifying one or more trends in the historical purchasing data;
predicting upcoming demand for goods or services during a second period of time that has not yet occurred;
generating a bill of materials based on the predicted upcoming demand for goods or services during the second period of time;
generating a request for bid (RFB) to provision the goods or services based on the predicted upcoming demand for goods or services during the second period of time and the generated bill of materials;
transmitting the RFB to a plurality of vendors, via a vendor hub;
receiving, via the vendor hub, a plurality of respective bids to provision the goods or services from the plurality of vendors;
selecting a first bid of the plurality of bids associated with a first vendor of the plurality of vendors; and
initiating, via the vendor hub, purchase of the goods or services from the first vendor.

16. The non-transitory, computer-readable medium of claim 15, the actions comprising:
receiving data defining one or more upcoming projects occurring during the second period of time; and
predicting the upcoming demand for the goods or services during the second period of time based on the identified trends and the one or more upcoming projects occurring during the second period of time.

17. The non-transitory, computer-readable medium of claim 15, the actions comprising:
receiving data from one or more tables identifying an enterprise's existing assets; and
predicting the upcoming demand for the goods or services during the second period of time based on the identified trends and the enterprise's existing assets.

18. The non-transitory, computer-readable medium of claim 15, the actions comprising:
searching one or more online marketplaces to identify one or more candidate new vendors;
recommending the one or more candidate new vendors for onboarding; and
providing the one or more candidate new vendors with access to the vendor hub.

19. The non-transitory, computer-readable medium of claim 15, the actions comprising:
collecting data associated with the first vendor; and
calculating one or more vendor metrics associated with the collected data.

20. The non-transitory, computer-readable medium of claim 19, the actions comprising:
identifying when the one or more vendor metrics fall below one or more respective threshold values that define a set of expected performance standards for the first vendor; and
offboarding the first vendor.
